(19) United States
(12) Patent Application Publication
(10) Pub. No.: US 2018/0041342 A1
(43) Pub. Date: Feb. 8, 2018

(54) DEVICE AND METHOD FOR SENDING AND VERIFYING A SIGNATURE

(71) Applicant: Siemens Aktiengesellschaft, München (DE)

(72) Inventor: Wenrong Weng, München (DE)

(21) Appl. No.: 15/537,550

(22) PCT Filed: Oct. 27, 2015
(86) PCT No.: PCT/EP2015/074781

§ 371 Date: Jun. 19, 2017

(30) Foreign Application Priority Data
Dec. 22, 2014 (DE) 10 2014 226 772.2

(51) Int. Cl. H04L 9/32; H04L 29/06

(52) U.S. Cl. CPC H04L 9/3247; H04L 63/123; H04L 63/0823; H04L 9/3268

(57) ABSTRACT

A sending device for sending a signature to at least one receiving device is provided. The sending device includes a sending unit being configured to send data to the at least one receiving device, the data including a plurality of frames, a receiving unit being configured to receive a request from the at least one receiving device to send a signature to the receiving device, the request including an indication indicating the frames of the plurality of frames being received by the at least one receiving device, and a computing unit being configured to compute a signature using the indicated frames, wherein the sending unit is configured to send the computed signature to the at least one receiving device. Further, a corresponding receiving device for verifying a signature from a sending device is provided.

### CROSS-REFERENCE TO RELATED APPLICATIONS

This application claims priority to PCT Application No. PCT/EP2015/074781, having a filing date of Oct. 27, 2015, based off of German application No. DE 102014226772.2, having a filing date of Dec. 22, 2014, the entire contents of which are hereby incorporated by reference.

### FIELD OF TECHNOLOGY

The following relates to a sending device for sending a signature to a receiving device and to a receiving device for receiving the signature and verifying the received signature. Further, embodiments of the present invention relate to a network system comprising a sending device and a receiving device. Moreover, embodiments of the invention relate to a method for sending a signature to a receiving device and to a method for verifying the signature.

### BACKGROUND

In many systems, a digital signature is used for providing an originality of content. The technique applies already to a wide range of applications like for example software delivery, photos, etc. Also signed video delivery or video export may be an application field. It can be for example an important factor for videos that are used as juristic evidence. Due to the nature of a signing procedure, verifying of signature succeeds only if the content delivered is completely binary identical to the original. A single wrong bit may cause a verification failure. In a packet-lossy network, as it is used in real time video communication, frame loss may occur and the content delivered is not the same to as it is delivered as one or more frames are missing at the receiver. A simple signing procedure, which is based on a comparison of a signature being calculated on the original content and a signature being calculated on the received content, therefore cannot be used.

### SUMMARY

An aspect relates to providing devices and methods a signing technique working also in packet-lossy networks, for example for session participants who expect to receive only particular parts of video sequences dynamically.

According to a first aspect, a sending device for sending a signature to at least one receiving device is provided. The sending device comprises a sending unit being configured to send data to the at least one receiving device, the data including a plurality of frames, a receiving unit being configured to receive a request from the at least one receiving device to send a signature to the receiving device, the request including an indication indicating the frames of the plurality of frames being received by the at least one receiving device, and a computing unit being configured to compute a signature using the indicated frames, wherein the sending unit is configured to send the computed signature to the at least one receiving device.

The respective unit, e.g. the computing unit, may be implemented in hardware and/or in software. If said unit is implemented in hardware, it may be embodied as a device, e.g. as a computer or as a processor or as a part of a system, e.g. a computer system. If said unit is implemented in software, it may be embodied as a computer program product, as a function, as a routine, as a program code or as an executable object.

As the computing unit of the sending device only computes a signature using data frames which are in fact received by the receiving device, a later comparison between the signature generated by the sending device and a comparison signature generated by the receiving device is also possible in packet-lossy networks.

In common systems, a sender generates a signature based on data and transmits the signature together with the data to a receiver. The receiver then extracts the signature from the data, eventually in combination with a decryption of the signature if the signature is encrypted, generates a comparison value using the received data and compares the comparison value and the received signature. When the comparison value and the signature are identical, the sender can be verified. However, if any part of the data is lost during the transmission, the receiver will generate the comparison value using different data (as some parts are missing) than the sender when generating the signature. Thus, the comparison in this case would fail.

To avoid such fail due to packet loss, the computing unit of the provided sending device generates or computes the signature using information from the receiving device which indicates which parts or frames of the data were really received. Thus, not received frames will not be used and considered during the signature computation.

Therefore, a signing procedure is provided which dynamically adapts the data used for signature generation or computation. The adaptation may be done in real time.

For computing the signature, any suitable method for computing a signature may be used.

According to an embodiment, the sending device further comprises a memory unit, wherein the computing unit is configured to compute a hash value of each frame of the plurality of frames and to store the computed hash values in the memory unit.

The computing unit may compute continuously for each frame of data to be sent by the sending device a hash value. These hash values are then stored in the memory unit.

According to a further embodiment, the computing unit is configured to select stored hash values from the memory unit based on the indicated frames and to compute the signature by encrypting the selected hash values using a private key.

When the sending device knows, which frames have been received by the receiving device, the computing unit may select the hash values being associated with these frames and compute the signature using these selected hash values. For this, the computing device may use a private key of the sending device.

According to a further embodiment, the computing unit is configured, when encrypting the selected hash values, to compute a total hash value over all selected hash values and to encrypt the total hash value using the private key.

After selecting the hash values, the computing unit determines a total hash value, for example by applying a hash function over all selected hash values. The private key may then be used for encrypting the total hash value, which results in the signature.

According to a further embodiment, the memory unit is configured to store the computed hash values in a lookup table being indexed by a sequence number of each frame.

Using a lookup table may provide an easy access to the stored hash values. The receiving unit may receive from the receiving device the sequence numbers of the received frames. Based on the sequence numbers, the computing unit may select the respective hash values.

According to a further embodiment, the computing unit is configured to use a hash function for computing the hash values, wherein the hash function is identical for each hash value.

The hash function being used for computing the hash values for each frame may be the same for all frames. Further, the hash function is known to the receiving device so that the sending device and the receiving device use the same hash functions. The hash functions may be known before any communication between the sending device and the receiving device or may be communicated when starting a communication.

Any embodiment of the first aspect may be combined with any embodiment of the first aspect to obtain another embodiment of the first aspect.

According to a second aspect, a receiving device for verifying a signature from a sending device is provided. The receiving device comprises a receiving entity being configured to receive data from the sending device, the data including a plurality of frames, a sending entity being configured to send a request to the sending device to send a signature, the request including an indication indicating the frames of the plurality of frames being received, wherein the receiving entity is configured to receive the signature from the sending device, and a computing entity being configured to compute a comparison value using the received frames and to verify the received signature by comparing the received signature with the comparison value.

The respective entity, e.g. the computing entity, may be implemented in hardware and/or in software. If said entity is implemented in hardware, it may be embodied as a device, e.g. as a computer or as a processor or as a part of a system, e.g. a computer system. If said entity is implemented in software, it may be embodied as a computer program product, as a function, as a routine, as a program code or as an executable object.

When the receiving device, or more precisely the receiving entity of the receiving device, receives data, it is determined which frames of the originally sent data are received. Based on this information or indication, the sending device generates a signature, as described above. The computing entity of the receiving device then compares the received signature with the comparison value, which is generated using the received frames. Based on the result of the comparison, the computing entity may decide whether the sending device or more precisely the signature of the sending device can be verified.

According to an embodiment, the sending entity is configured to send the request including a sequence number of each frame being received.

Each frame may comprise a sequence number. These sequence numbers may be sent to the sending device.

According to a further embodiment, the computing entity is configured to compute the comparison value by computing a hash value of the received frames.

Like the sending device when generating the signature, the computing entity of the receiving device may compute a hash value of all received frames.

According to a further embodiment, the computing entity is configured to use a hash function being identical to a hash function used by the sending device.

In order to get comparable results, the hash functions being used by the receiving device and the sending device are identical.

According to a further embodiment, the computing entity is configured to decrypt the received signature using a public key of the sending device, before comparing the received signature with the comparison value.

The public key may for example be made available to the receiving device by the sending device. This can be done when starting a communication. The public key may also be made available via a central unit, like a server.

Based on the described sending device and receiving device, the verification of a signature generated as described may still be successful even if packet loss occurred during the data transmission, which may be a video transmission. As the signatures are generated dynamically and applied only to the data that has been received, it may be more difficult for an attacker to emulate a signature.

The described way of generating a signature may for example be useful during a live session, for example a video live session. In such a case, multiple participants may sign in and leave at different times. The contents received by different participants may therefore be different. A static signature might be failed to verify. With the described dynamic signing procedure, each receiving device could receive the signature which is applied to the number of frames the respective receiving device received, and could be verified successfully.

Any embodiment of the second aspect may be combined with any embodiment of the second aspect to obtain another embodiment of the second aspect.

According to a third aspect, a network system for verifying a sending device to at least one receiving device is provided. The network system comprises a sending device as described herein, and at least one receiving device as described herein.

It should be noted that any device within the network may work as sending device or receiving device. A device, which is at one instant a sending device, may be in the next instant a receiving device, and vice versa. Thus, one device may comprise the units and features of a sending device as described herein as well as the units and features of a receiving device as described herein.

According to an embodiment, the network system is configured to perform video communication between a plurality of devices, the plurality of devices including the sending device and the at least one receiving device.

The video communication may be performed between multiple devices, each of which can have sending and receiving functionalities as described above.

Any embodiment of the third aspect may be combined with any embodiment of the first aspect, the second aspect or the third aspect to obtain another embodiment of the third aspect.

According to a fourth aspect, a method for sending a signature to at least one receiving device is provided. The method comprises the following steps: sending data to at least one receiving device, the data including a plurality of frames, receiving a request from the at least one receiving device to send a signature to the receiving device, the request including an indication indicating the frames of the plurality of frames being received by the at least one receiving device, computing a signature using the indicated frames, and sending the computed signature to the at least one receiving device.

According to a fifth aspect, a method for verifying a signature from a sending device is provided. The method comprises receiving data from the sending device, the data including a plurality of frames, sending a request to the sending device to send a signature, the request including an indication indicating the frames of the plurality of frames being received, receiving the signature from the sending device, computing a comparison value using the received frames, and verifying the received signature by comparing the received signature with the comparison value.

According to a further aspect, embodiments of the invention relate to a computer program product comprising a program code for executing the above-described method for sending a signature to at least one receiving device and/or the above-described method for verifying a signature from a sending device when run on at least one computer.

A computer program product, such as a computer program means, may be embodied as a memory card, USB stick, CD-ROM, DVD or as a file which may be downloaded from a server in a network. For example, such a file may be provided by transferring the file comprising the computer program product from a wireless communication network.

The embodiments and features described with reference to the devices and the system of embodiments of the present invention apply mutatis mutandis to the methods of the present invention.

Further possible implementations or alternative solutions of embodiments of the invention also encompass combinations that are not explicitly mentioned herein of features described above or below with regard to the embodiments. The person skilled in the art may also add individual or isolated aspects and features to the most basic form of the invention.

### BRIEF DESCRIPTION

Some of the embodiments will be described in detail, with reference to the following figures, wherein like designations denote like members, wherein:

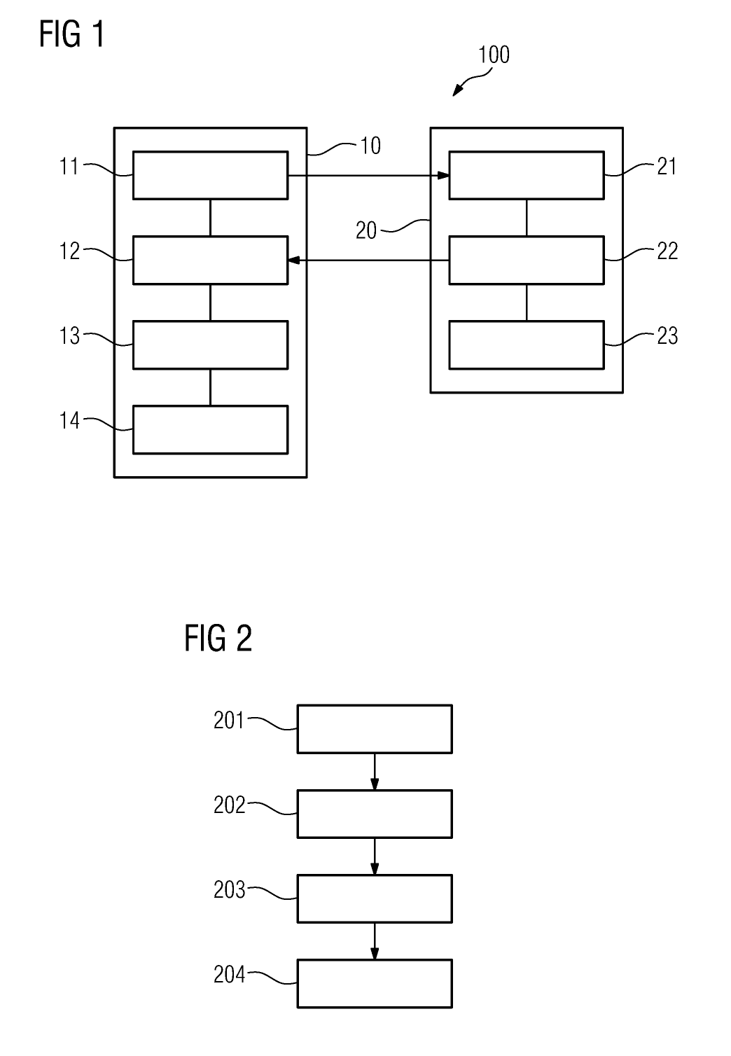

FIG. 1 shows a schematic block diagram of an embodiment of a sending device and a receiving device within a network system;

FIG. 2 shows an embodiment of a sequence of method steps for sending a signature to a receiving device; and

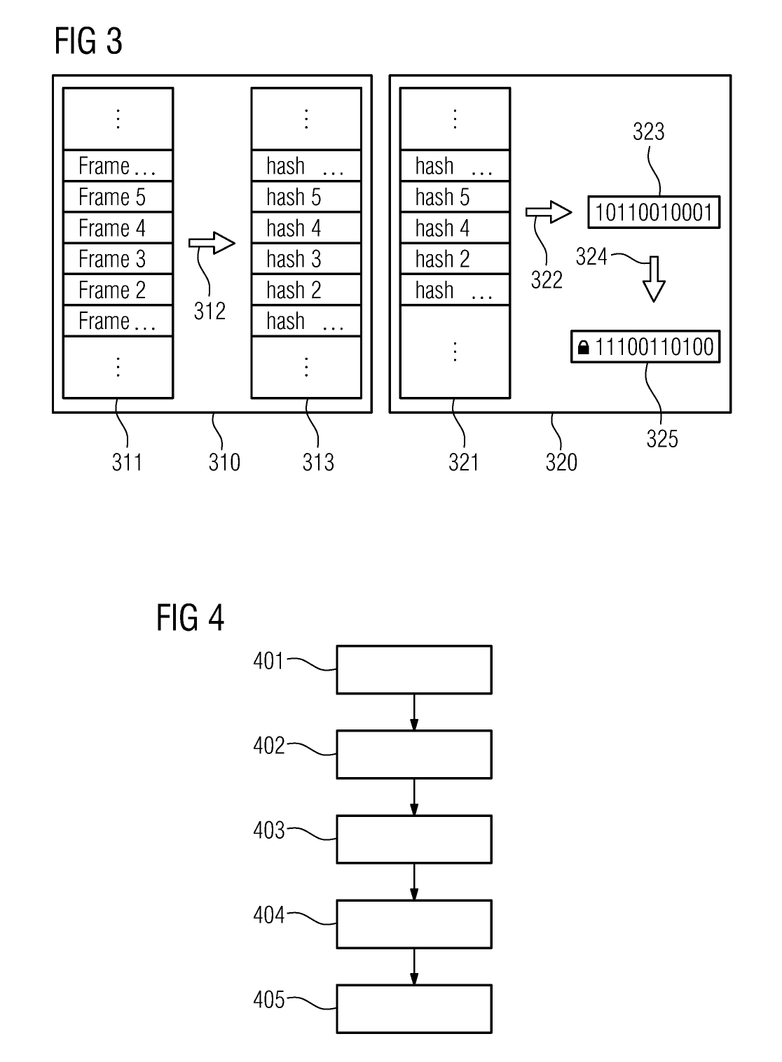

FIG. 3 shows an embodiment of a sequence of method steps for computing the signature; and

FIG. 4 shows an embodiment of a sequence of method steps for verifying a signature from a sending device.

In the Figures, like reference numerals designate like or functionally equivalent elements, unless otherwise indicated.

### DETAILED DESCRIPTION

FIG. 1 shows a network system 100 comprising a sending device 10 and a receiving device 20. It should be noted that the network system may comprise a plurality of devices and that each device of the plurality of devices may be a sending device 10 or a receiving device 20 or may be a combination of them. This means that the sending device 10 may also have the functionality of the receiving device 20 and vice versa.

The sending device 10 comprises a sending unit 11, a receiving unit 12, a computing unit 13 and a memory unit 14.

The receiving device 20 comprises a receiving entity 21, a sending entity 22 and a computing entity 23.

The sending unit 11 sends data 311 to the receiving entity 21.

The computing entity 23 determines sequence numbers of the frames being contained in the data 311 and the sending entity 22 sends a request to the receiving unit 12 to generate or compute and send a signature to the receiving device 20. The request includes the sequence numbers of the received frames.

The computing unit 13 continuously computes hash values of the frames within the data and stores the hash values in the memory unit 14. When computing the signature, the computing unit 13 selects hash values from the memory unit 14 using the sequence numbers of the corresponding frames and computes a signature 325 using these hash values.

Subsequently, the sending unit 11 sends the computed signature 325 to the receiving entity 21.

The computing 23 then computes a comparison value using the received frames and verifies the received signature 325 by comparing the received signature with the comparison value.

FIG. 2 shows a method for sending a signature 325 to a receiving device 20. The method comprises the following steps 201 to 204.

In step 201, data 311 is sent to at least one receiving device 20. The data includes a plurality of frames.

In step 202, a request is received from the at least one receiving device 20 to send a signature 325 to the receiving device 20. The request includes an indication indicating the frames of the plurality of frames being received by the at least one receiving device 20.

In step 203, a signature 325 is computed using the indicated frames.

In step 204, the computed signature 325 is sent to the at least one receiving device 20.

FIG. 3 shows a method for computing the signature 325, i.e. shows step 203 in detail.

Step 203 can be performed in a first operation 310 and a second operation 320. The first operation 310 is performed continuously for every frame of data 311. To each frame of the data 311, a hash function 312 is applied. The results of the hash function 312 are stored in the memory unit 14 in the form of a hash map 313 with lookup functionality using the sequence number of each frame.

The second operation 320 acts on the hash map 313 and is only triggered on request by the receiving device 20, since the receiving device 20 may not receive all the frames due to a packet-lossy network. In the example of FIG. 3, frame 3 is lost, and therefore the receiving device 20 requests a signature excluding frame 3.

The computing unit 13 of the sending device 10 uses only selected frames as hash data 321, i.e. all requested frames. A hash function 322 is applied to the hash data 321 for generating a total hash value 323. The total hash value 323 is then encrypted 324 using the private key of the sending device 10. This results in the signature 325.

At the receiving device, the verification of signature takes the first operation 310 on received frames, excluding storing the hash values in the hash map 313 and then takes the second operation 320 with the public key of the sending device 10. The verification succeeds if the calculated hash value is the same as the value sent by the sending device 10.

FIG. 4 shows a method for verifying a signature from a sending device. The method comprises the following steps 401 to 405.

In step 401, data 311 is received from the sending device 10. The data includes a plurality of frames.

In step 402, a request is sent to the sending device 10 to send a signature 325. The request includes an indication indicating the frames of the plurality of frames being received.

In step 403, the signature 325 is received from the sending device 10.

In step 404, a comparison value is computed using the received frames.

In step 405, the received signature 325 is verified by comparing the received signature 325 with the comparison value.

Although the present invention has been described in accordance with preferred embodiments, it is obvious for the person skilled in the art that modifications are possible in all embodiments.

1. A sending device for sending a signature to at least one receiving device, the sending device comprising:
a sending unit configured to send data to the at least one receiving device, the data including a plurality of frames;
a receiving unit configured to receive a request from the at least one receiving device to send a signature to the receiving device, the request including an indication indicating frames of the plurality of frames being received by the at least one receiving device, and
a computing unit configured to compute a signature using the indicated frames of the plurality of frames,
wherein the sending unit is configured to send the computed signature to the at least one receiving device.

2. The sending device according to claim 1, further comprising
a memory unit, wherein the computing unit is configured to compute a hash value of each frame of the plurality of frames and to store the computed hash values in the memory unit.

3. The sending device according to claim 2, wherein the computing unit is configured to select stored hash values from the memory unit based on the indicated frames and to compute the signature by encrypting the selected hash values using a private key.

4. The sending device according to claim 3, wherein the computing unit is configured, when encrypting the selected hash values, to compute a total hash value over all selected hash values and to encrypt the total hash value using the private key.

5. The sending device according to claim 2, wherein the memory unit is configured to store the computed hash values in a lookup table being indexed by a sequence number of each frame.

6. The sending device according to claim 2, wherein the computing unit is configured to use a hash function for computing the hash values, wherein the hash function is identical for each hash value.

7. A receiving device for verifying a signature from a sending device, the receiving device comprising:
a receiving entity being configured to receive data from the sending device, the data including a plurality of frames;
a sending entity being configured to send a request to the sending device to send a signature, the request including an indication indicating frames of the plurality of frames being received, wherein the receiving entity is configured to receive the signature from the sending device, and
a computing entity being configured to compute a comparison value using the received frames and to verify the received signature by comparing the received signature with the comparison value.

8. The receiving device of claim 7, wherein the sending entity is configured to send the request including a sequence number of each frame being received.

9. The receiving device of claim 7, wherein the computing entity is configured to compute the comparison value by computing a hash value of the received frames.

10. The receiving device of claim 9, wherein the computing entity is configured to use a hash function being identical to a hash function used by the sending device.

11. The receiving device of claim 7, wherein the computing entity is configured to decrypt the received signature using a public key of the sending device, before comparing the received signature with the comparison value.

12. A network system for verifying a sending device to at least one receiving device, the network system comprising:
a sending device according to claim 1, and
at least one receiving device according to claim 1.

13. The network system according to claim 12, wherein the network system is configured to perform video communication between a plurality of devices, the plurality of devices including the sending device and the at least one receiving device.

14. A method for sending a signature to at least one receiving device, the method comprising:
sending data to at least one receiving device, the data including a plurality of frames,
receiving a request from the at least one receiving device to send a signature to the receiving device, the request including an indication indicating the frames of the plurality of frames being received by the at least one receiving device,
computing a signature using the indicated frames, and
sending the computed signature to the at least one receiving device.

15. A method for verifying a signature from a sending device, the method comprising:
receiving data from the sending device, the data including a plurality of frames,
sending a request to the sending device to send a signature, the request including an indication indicating the frames of the plurality of frames being received,
receiving the signature from the sending device,
computing a comparison value using the received frames, and
verifying the received signature by comparing the received signature with the comparison value.
